(19) United States
(12) Patent Application Publication
(10) Pub. No.: US 2017/0315980 A1
(43) Pub. Date: Nov. 2, 2017

(54) SYSTEM THAT DOCUMENTS WORK TO BE PERFORMED AT A SPECIFIC LOCATION OVER A SPECIFIC PERIOD OF TIME BY SPECIFIC PERSONNEL ON DESIGNATED EQUIPMENT BY GUIDING A HUMAN USER TO CREATE A UNIQUE, ACCURATE, AND COMPLETE METHOD OF PROCEDURE DOCUMENT

(71) Applicant: EdgeConneX EDC North America, LLC, Herndon, VA (US)

(72) Inventor: Lance B. Devin, Vienna, VA (US)

(73) Assignee: EdgeConneX EDC North America, LLC, Herndon, VA (US)

(21) Appl. No.: 15/142,093

(22) Filed: Apr. 29, 2016

(51) Int. Cl. G06F 17/24; G06Q 10/10

(52) U.S. Cl. CPC G06F 17/248; G06F 17/243; G06Q 10/10

(57) ABSTRACT

A system that documents work to be performed at a specific location over a specific period of time by specific personnel on designated equipment by guiding a human user to create a unique, accurate, and complete document.

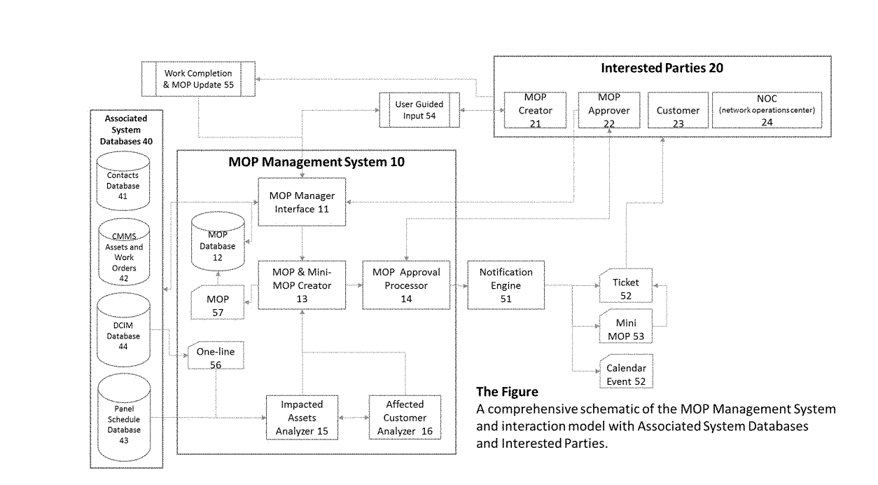

### FEDERALLY SPONSORED RESEARCH STATEMENT

Not Applicable

### REFERENCE TO SEQUENCE LISTING, A TABLE OR A COMPUTER PROGRAM LISTING

Not applicable

### BACKGROUND OF THE INVENTION

### Field of the Invention

### Prior Art

### Brief Summary of the Invention

It is the objective of the inventive, MOP system, to create and store complete, accurate, and effective Methods of Procedure (MOPS) that defines the work and timing of said work to be performed in a critical infrastructure environment. Additionally, the MOP System, will guide the data entry and data retrieval from a variety of associated system databases based on MOP Creator guided input and two-way interaction. Additionally, the inventive system manages the approval process for the work to be performed. The inventive system uses machine based algorithms to automate the creation of distributable MOP documents and tickets to interested parties impacted or affected by the MOP.

A Method of Procedure (“MOP”) is a formalized document that describes maintenance procedures that will be performed by specific people, on designated assets in a defined location, and when that work will be performed over a specific period of time. In the preferred embodiment, these assets are located in critical infrastructure environment and facility that provide continuous essential services to a set of interested parties, including customers and consumers of said services.

While a Method of Procedure does not have a rigid definition of structure, definition, or format, a well-constructed MOP, and the MOP in the preferred embodiment, contains the following elements:
Unique MOP Identifier
Location: Address of the facility, specific rooms or places in that location
Start and End times of work to be performed
Work Risk Level
Submitter information: Name, Phone Number and Email
Type: Corrective Maintenance, Engineering work, Preventive Maintenance, etc.
Status: Pending, Approved, In Progress, Completed, etc.
Critical Contacts: MOP Author, Consultants, MOP Manager, Approvers, Interested Parties, Emergency Personnel, Vendors, etc.
Scope and Purpose: Written description of the work and the purpose of the work to be performed
Responsibilities List: A list of persons and the actions they will be taking for the duration of the MOP
Tasks:
   A list of pre-tasks that may have to performed prior to the work being performed
   Work Phases: The actual work being performed on specific assets, along with the steps that would constitute that task
Back-out plans: A list of steps and tasks that would be followed if for any reason the defined tasks fail to work as designed
Documents: Any pertinent documents to the work to be performed (e.g. Equipment manuals, diagrams, maps, protective clothing, etc.

The inventive system is used by a MOP creator/submitter. The inventive system guides the MOP creator through all of the required components of the MOP and ensures the completeness of the MOP. Additionally, the inventive system provides simplified, intelligent access and retrieval of data stored in multiple, associated systems that contain the information related to contacts, tasks, work phases and other components of the MOP. The inventive system also allows for free-form data entry when other systems cannot provide all of the required information.

Proposed completed MOP is routed to a set of approvers, whose role is to review the contents of the MOP for effectiveness, review the MOP for completeness, and either approve or reject the MOP as written. If a MOP is rejected it can be modified for resubmittal. If a MOP is approved, interested parties are notified of the approval and notified to varying degrees of the MOP contents. In the preferred embodiment a work/mop ticket is automatically created by the MOP System in order to maintain a record of the work and notify impacted interested parties. The inventive system also knows how the customer is integrated into the critical infrastructure environment and includes in the notification the specific customer equipment that are impacted by the MOP.

### DESCRIPTION OF FIGURE

The FIGURE: A comprehensive schematic of the MOP Management System and interaction model with Associated System Databases and Interested Parties.

### DETAILED DESCRIPTION OF THE INVENTION

### Explanation of Invention Definitions and Explanation of Terms Specific to the Disclosure

MOP Management System 10 (“MOP System 10”): MOP System 10, the invention, is a bespoke application system, programmed in a commercially available programming language, consisting of the following components: MOP Manager Interface 11, MOP Database 12, MOP & Mini-MOP Creator 13, MOP Approval Processor 14, Affected Customer Analyzer 16 and Impacted Asset Analyzer 15. MOP System 10 elicits input from MOP Creator 21, gets additional information from Impacted Asset Analyzer 15 and Affected Customer Analyzer 16, then creates a MOP document, a smaller notification document called a Mini MOP. The MOP and Mini-MOP are stored in MOP Database 12. MOP System 10 use MOP Approval Processor 12 to manage MOP Approver 22, then uses Notification Engine 51 to automatically communicate to Interested Parties 20.

MOP Manager Interface 11: A bespoke application component, programmed in a commercially available programming language. It elicits guided input from MOP Creator 21 through a web interface in order to complete the information gathering required for a MOP. MOP Manager Interface 11 provides the visual application component to MOP System 10.

MOP Database 12: A commercially available relational database is used to define a bespoke set of tables and relational database structures that stores all information required for a complete MOP document and the MOP System 10.

MOP & Mini-MOP Creator 13: A bespoke application component, programmed in a commercially available programming language. It creates two documents of standard industry types (PDF, Microsoft Word Doc, etc), in a consistent format for consumption by Interested Parties 20. MOP document contains all the information collected through MOP Manager Interface 11 and other components of MOP System 10. Mini-MOP 53 contains a subset of information collected through MOP Manager Interface 11 to be presented to Customer 23.

MOP Approval Processor 14: A bespoke application component, programmed in a commercially available programming language. A MOP created in MOP System 10 by MOP Creator 21, must be approved by a MOP Approver 22, who is not the same person as MOP

Creator 21: MOP Approver 22 is one or more persons assigned to review MOPs for one or more critical infrastructure environments. MOP Approval Processor 14 ensures that the right MOP Approver 22 is chosen for a particular MOP and tracks whether the MOP has been accepted or rejected. Once accepted MOP Approval Processor 14 communicates to Notification Engine 51 that a Ticket 52 and Mini MOP 53 can be sent to Interested Parties as determined by Affected Customer Analyzer 16 and retrieved contact information from Contacts Database 41.

Impacted Asset Analyzer 15: A bespoke application component, programmed in a commercially available programming language. Impacted Asset Analyzer 15 extracts the data collected by MOP Manager Interface 11 to identify the assets undergoing work. Those assets are passed to Affected Customer Analyzer 16.

Affected Customer Analyzer 16: A bespoke application component, programmed in a commercially available programming language. Affected Customer Analyzer associates those assets extracted by Impacted Assets Analyzer 15 to Customer 13 assets stored in Panel Schedule Database 43. It also uses computer programming rules that know the preferred embodiment of the data center in order to associate equipment to a customer for equipment not stored in Panel Schedule Database 43. This component identifies the list of Customers 13 that will be notified using Notification Engine 51.

Associated Systems Databases 40: A series of database maintained by other systems related to data center operations, the preferred embodiment. These include Contacts Database 41, CMMS Assets and Work Orders database 42 and Panel Schedule Database 43.

Contacts Database 41: A commercially available relational database is used to define a bespoke set of tables and relational database structures that store information about Interested Parties 20 and the different means to contact them (e.g. eMail, Phone, Mobile Phone, etc.)

CMMS Assets and Work Orders Database 42: A commercially available relational database is used to define a bespoke set of tables and relational database structures for a CMMS (Computerized Maintenance Management System) system that is a proprietary version of commercially available software. The CMMS system is responsible for storing information with regards to assets. It manages work to be done within the Data Center as it pertains to those assets. Typical work defined in the system includes maintenance on asset equipment and customer requests for power.

Panel Schedule Database 43: A bespoke set of tables in a commercially available database system, used for the tracking of circuit breaker positions and availability and Customer 23 assigned to the circuit breaker.

DCIM Database 44: (DCIM: Data Center Information Management System) A bespoke set of tables in a commercially available database system, used for the monitoring and information gathering related to a data center. With respect to the invention, the database stores the electrical diagram for the data center which is called the One-Line 56

Notification Engine 51: A bespoke application integrated into the inventive system. It uses industry standard protocols for outbound communications including but not limited to SMS, SMTP, etc. Notification center 6 uses templates for communication that draws information from various other systems in the invention as outlined below.

Ticket 52: A collection of grouped information, stored in a bespoke application (ticketing system) used for recording the status of a set of activities. Ticket 52 is accessible through a ticketing system interface and other communications protocols. In the preferred embodiment, the activities and status thereof pertain to the work tasks defined in MOP System 10.

Mini-MOP 53: A document of standard industry types (PDF, Microsoft Word Doc, etc), in a consistent format for consumption by Interested Parties 20. Mini-MOP 53 contains a subset of information collected through MOP Manager Interface 11 to be presented to Customer 23.

User Guided Input 54: An interaction model between MOP Creator 21 and MOP Manager Interface 11. The interaction model is input provided by MOP Creator 21 to prompts by MOP Manager Interface 11. Inputs from MOP Creator may change the prompts and availability of data from MOP Manager Interface 11.

Work Completion & MOP Update 55: The interaction and process model between Interested Parties 20 and MOP System 10 as it applies to the status of MOPs in MOP System 10.

One Line 56: The systematic representation of an electrical system. Stored for the purposes of the inventive system in DCIM Database 44.

MOP 57: A Method of Procedure (“MOP”) is a formalized document that describes maintenance procedures that will be performed on assets and when that work will be performed. In the preferred embodiment, these assets are located in critical infrastructure environment and facility, meaning facilities that provide essential services, all the time, to a set of interested parties, or consumers of said services.

MOP Creator 21: Person responsible for interacting with MOP System 10 to enter data.

MOP Approver 22: Person, explicitly not MOP Creator 21, responsible for reviewing the MOP for completeness and accuracy.

Customer 23: Person or persons who use the services impacted by work performed in the critical infrastructure facility.

NOC 24 (“Network Operations Center): A person or persons responsible for coordinating activities and Interested Parties 20 defined by the MOP.

For the purposes of this disclosure a critical infrastructure environment is defined as a constructed system that provides uninterrupted services. A data center is considered to be a specific form of a critical infrastructure environment that provides the service of power and cooling to computer equipment.

In the instance of the present invention, MOP Creator 21 interacts with MOP System 10 through MOP Manager Interface 11. MOP Manager Interface 11 guides the user through a set of requirement data that constitute MOP 57. In the preferred embodiment, relating to critical infrastructure environments and facilities, particularly data centers, MOP System 10 requires:
General MOP Information: MOP Title, Activity Types (corrective maintenance, preventive maintenance, engineering tasks, etc.), Site/Location of Work, Risk Level, affected areas and acknowledgement of work standards for critical environments.
Attachments: Addition of critical documents required to perform work in the site/location. In the preferred embodiment, these include backout plans, work phases, Original Equipment Manufacturer manuals, electrical switching tag orders, etc.
Contact Information: Information pertaining to persons in different roles as it pertains to the MOP and the work to be performed. Mandatory and non-mandatory personnel are listed, with mandatory personnel as a requirement. These contacts: MOP Author 21, MOP Manager, Network Operations Center 24, Emergency/Safety personnel, etc.
Scope and Purpose: Detailed description of work to be performed, purpose, expected outcomes, equipment.
Responsibilities: A contact (Interested Parties 20, maintenance vendors, etc.) associated with a description of their responsibility with respect to work.
Pre-Tasks: Responsible Party, Description of the pre-task and protective gear assignment.
Work Phases: One or more descriptions of work and the steps required to perform the work. Work Phases may be selected from CMMS Assets and Work Orders 42, or manually entered by MOP Creator 21.
Back Out Plans: A description of effort or work that must occur if any part of the MOP process fails.

Guided, Intelligent and Automated MOP Creation: Based on inputs from MOP Creator 21, MOP System 10 makes intelligent selections as to the data that can come from Associated System Databases 40 to be used by the system, and for data that is required by MOP System 10. For example, selection of Site/Location by MOP Creator 21 allows MOP System 10 to automatically filter work orders from CMMS Assets and Work Orders 42 that are only for that Site/Location. MOP System 10 asks only for work orders that have certain statuses, for example the status of open. Another example, in the preferred embodiment of a critical infrastructure environment such as a data center, work performed on electrical equipment requires a document called Switching Tags. This document is not required for work on mechanical equipment. The inventive system intelligently prompts for required information from MOP Creator 21 based on equipment type. In this way, the inventive system ensures accuracy and completeness of MOP 57.

MOP System 10 integrates with Associated System Databases 40 to auto-populate required MOP 57 information. MOP Creator 21 must specify responsible parties for work to be performed. Work can include pre-tasks, work, post-work tasks, and ancillary tasks. All work must designate a responsible person and their contact information. MOP System 10 presents contacts from CMMS Assets and Work Orders Database 42, Contacts Database 41, and offers pre-filtered choices for MOP Creator 21 to choose from. MOP System 10 also allows MOP Creator 21 to enter other responsible parties not stored in Associated System Databases 40. Again, choices are pre-filtered based on Site/Location, or the specific assets associated to the work.

MOP Creator 21 may select one or more Work Phases from CMMS Assets and Work Orders 42 or Work Phases may be manually entered. A selection from CMMS Assets and Work Orders 42, auto-populates MOP 57 with information such as Work Phase Title, Responsible Party, Planned Date and Task Steps. MOP Creator 21 has only to fill in the planned start time and duration for that Work Phase. If the data is available MOP System 10 can retrieve from CMMS Assets and Work Orders 42 a standard amount of time for pre-defined work. MOP System 10 ensures data accuracy by retrieving all relevant information automatically from Associated System Database 40. If MOP Creator 21 chooses to manually enter a Work Phase, the MOP System 10 ensures that all required fields listed above are completely filled in.

MOP System 10 automatically orders the work phases according to the planned start time datum so that MOP 57 contains an accurate description of work phases across time.

Data Entry Post Processing: After MOP System 10 guides MOP Creator 21 through the creation of MOP 57 and before MOP System 10 saves MOP 57 to MOP Database 12, MOP and Mini-MOP Creator 13 takes two post-processing steps. First MOP & Mini-MOP Creator 13 programmatically calls Impacted Assets Analyzer 15 to determine, extract and list which assets in the critical infrastructure environment are impacted. These assets were identified by MOP Creator 21's selection of work phases from CMMS Assets and Work Orders 42. In the preferred embodiment of a data center, and specifically related to electrical power in the data center, the asset list extracted by Impacted Assets Analyzer 15 is programmatically queried against One-Line 56 stored in DCIM Database 44 to find any other electrical equipment assets downstream (“the flow of current through the system to a customer asset”) of the assets being worked on, including the circuit breakers data stored in Panel Schedule Database 43. Panel Schedule Database 43 stores not only the circuit breaker data, but Customer 23 associated with that circuit breaker. Impacted Assets Analyzer 15 programmatically passes all impacted assets to Affected Customer Analyzer 16 which in turn queries Panel Schedule Database 43 for the list of Customers 23. Affected Customer Analyzer programmatically communicates selected Customers 23 to MOP & Mini-MOP Creator 13 which in turn stores that information in MOP Database 12.

Approvals and Notifications: MOP Management System 10, having completed the data gathering stage, proceeds to approvals and notifications. Each critical infrastructure environment is assigned to a hierarchy of MOP Approvers 22. Based on the critical environment selection made by MOP Creator 21, MOP Approval Processor 14 uses Notification Engine 51 to create a communication to assigned MOP Approver 22. If MOP Approver 22 doesn't respond to MOP Approval Processor 14 in a specified period of time, a different MOP Approver 22 may be selected. Never may MOP Approvers 22 be the same as MOP Creator 21. MOP Approver 22 accepts or denies MOP 57 using MOP Manager Interface 11. A rejected MOP 57 is routed by MOP Approval Processor 14 back to MOP approver 22 for modification.

MOP 57 accepted by MOP Approver 22 triggers MOP Manager System 10 to use Notification Engine 51 to create three separate communiques. Ticket 52 is created and communicated to Interested Parties 20 and specific Customers 23 as determined by the Affected Customer Analyzer 16 as described previously. Ticket 52 serves as a common vehicle for status updates to Interested Parties 20. Mini-MOP 53, a subset of MOP 57 information pertinent to Customer 23, is communicated through Ticket 52. The last communication is Calendar Event 52 which is submitted to a commercially available calendaring system (e.g. Microsoft Outlook, Microsoft Exchange, Google Calendar, etc.). Each critical infrastructure environment has its own calendar, and Calendar Event 52 is sent to the specific critical infrastructure environment calendar specified by MOP Creator 21 in MOP 57.

MOP Management System 10 must be updated by MOP Creator 21 with the status of MOP 57. A completed MOP 57 is retained in MOP Database 12 and is made un-editable so that MOP 57 stands as a final and unalterable record of events in the critical infrastructure environment. MOP Manager System 10 may be used to search and retrieve MOPs 57 from MOP Database 12.

MOP Templates: MOP Management System 10 allows MOP Creator 21 to use a previously-created MOP 27 to be the starting point for a new MOP 27. Because the same work may be performed across different critical infrastructure environments, many of the data associated with MOP 27 may be identical. MOP Creator 21 can change as appropriate the MOP 27 template to fit the need but significantly reduce the data input process. MOP Management System 10 ensures that an identical MOP 27 may not be created.

1. A method of documenting work, whereby a system guides a human user to create a unique, accurate, and complete document that defines work to be performed at a specific location over a specific period of time by specific personnel on designated equipment including the steps of:
prompting and guiding said human user through accurate creation of said document
restricting data entry values based on prior data entry values
querying databases of ancillary systems to auto-populate parts of said document
ensuring that said completed document is unique

2. The method of claim 1 adding the step of systematically reviewing and ensuring said document is complete and accurate

3. The method of claim 1 adding the step of creating and using a template for said document

4. The method of claim 2 adding the step of creating and using a template for said document

5. A method of documenting work to be performed on assets located in a critical infrastructure environment, whereby a system comprised of multiple ancillary and complementary systems, guides a human user to create a unique, accurate, and complete document that defines work to be performed at a specific location over a specific period of time by specific personnel on designated equipment including the steps of:
creating and using a template for said document
prompting and guiding said human user through accurate creation of said document
restricting data entry values based on prior data entry values
querying databases of ancillary systems to auto-populate and verify parts of said document
reviewing and ensuring said document is complete and accurate
ensuring that said document is unique
